(19) United States
(12) Patent Application Publication
(10) Pub. No.: US 2001/0015309 A1
(43) Pub. Date: Aug. 23, 2001

(54) Bill handling machine

(76) Inventor: Yoshiaki Ikuta, Himeji-Shi (JP)

Correspondence Address: WENDEROTH, LIND & PONACK, L.L.P., 2033 K STREET N. W., SUITE 800, WASHINGTON, DC, 20006-1021, US

(21) Appl. No.: 09/789,801

(22) Filed: Feb. 22, 2001

(30) Foreign Application Priority Data
Feb. 22, 2000 (JP) 2000-44188
Feb. 22, 2000 (JP) 2000-44202

(51) Int. Cl. G07F 7/04

(52) U.S. Cl. 194/206

(57) ABSTRACT

The invention includes a bill processing unit into which a bill is fed and in which the bill is discriminated. The bill that has been discriminated and approved by the bill processing unit is received and stored by a storage unit. The bill processing unit and the storage unit are separated by a partition. A passage opening is formed in the partition through which the bill passes. According to the invention, even if the bill processing unit is destroyed, the bills in the storage unit may not be stolen. That is, protection against steal may be improved.

### BACKGROUND OF THE INVENTION

1. Field of the Invention

This invention relates to a bill handling machine, in particular to a bill handling machine that can store a bill, which has been deposited through a bill deposit/withdrawal unit, in a storage unit that is separated from the bill deposit/withdrawal unit.

2. Description of the Related Art

There is known a machine including: a bill deposit/withdrawal unit that can conduct a bill depositing process and a bill refunding process, and a storage unit (safe unit) that can store bills that has been deposited through the bill deposit/withdrawal unit, from Japanese Patent Laid-Open Publication No.10-329975. In the machine, the bill deposit/withdrawal unit and the storage unit are separated, so that protection against steal may be improved because there is no bills in the bill deposit/withdrawal unit.

In addition, in the machine, the bill deposit/withdrawal unit and the storage unit are disposed apart from each other. Then, the bill deposit/withdrawal unit and the storage unit are connected with each other via an air tube. The air tube is adapted to transfer the bills in both directions by making use of Venturi effect.

That is, the bills are transferred through the air tube by an air pressure. Thus, the above machine have to have a source of the pressured air, some actuators, some pressure-adjusting means and/or some other incidental instruments. Therefore, the machine may be extremely complicated and more costly. In addition, the air tube may be jammed with the bills because the bills are transferred together with the pressured air. Furthermore, it is difficult to surely deliver the bills into the air tube, that is, a mechanism for delivering the bills into the air tube is complicated unavoidably.

In addition, there is known an automatic bill refunding machine that can refund a plurality of kinds of bills from Japanese Patent No. 2674899. The number of safes included in the machine is variable dependently on the number of kinds of bills that are ready for refunding.

In detail, the machine includes a or more box-like refunding modules that can be removably fitted in a main body of the machine and that can be piled up. The box-like refunding module has: a horizontal safe, a feeding-out part that can feed out a bill from an end part of the safe, a first passage through which the fed bill is transferred, and a second passage that connects with the first passage and that can also transfer a bill received at another position. Thus, the number of safes may be adjusted by changing the number of piled refunding modules.

Considering the world situation about the bills, many kinds of bills are circulated in one country. In addition, in some countries in Europe or the like, bills of adjacent other countries are also used widely. Thus, in such a country, a financial institution such as a bank has to deal with many kinds of bills. On the contrary, there are many cases wherein the machine that can deal with only one kind of bill is sufficient.

The above conventional machine has been developed only for refunding the bills. That is, the machine is not applicable to a circulating-type bill depositing and dispensing machine wherein the bills that has been deposited can be refunded again. In other words, there is still no circulating-type bill depositing and dispensing machine that can suitably keep up with increase or decrease of the number of kinds of the bills.

### SUMMARY OF THE INVENTION

Therefore, the object of this invention is to provide a bill handling machine comprising a bill processing unit that can be operated by customers and a storage unit that can store bills that has been deposited, the bill processing unit and the storage unit being separated, the bills being surely transferred without complicated mechanisms and protection against steal being improved.

In addition, the object of this invention is to provide a circulating-type bill depositing and dispensing machine that can effectively function in various cases, for example in a case wherein many kinds of bills have to be dealt with, in a case wherein only small kinds of bills (in particular, only one kind of bill) have to be dealt with or in a case wherein a plurality of kinds of stored bills are allowed to intermingle with each other.

Thus, this invention is characterized by following features. That is, this invention is a bill handling machine comprising: a bill processing unit into which a bill is fed and in which the bill is discriminated; a storage unit that can receive and store the bill that has been discriminated and approved by the bill processing unit; a partition that separates the bill processing unit and the storage unit; and a passage opening formed in the partition through which the bill passes.

According to the feature, the bill processing unit and the storage unit are separated by the partition, and the bill processing unit and the storage unit are connected with each other only via the passage opening through which the bill can pass. Thus, the bills once stored in the storage unit may be stored safely. That is, it is prevented that the bills are stolen even if the bill processing unit is destroyed.

In addition, since the bills are transferred through the passage opening formed in the partition, a distance of transfer to the storage unit may be much shorter. Thus, possibility that a jam of a passage with the bills happens may be reduced extremely. Furthermore, since the passage structure has to have no special mechanisms, the machine is advantageous in cost.

Preferably, the bill processing unit may have a depositing part into which bills are inserted. In addition, the bill processing unit may have a refunding part from which the bill that has been discriminated and not approved is paid back. In addition, the bill processing unit may have a temporary storing part in which the bill can be temporarily stored.

In detail, for example, the partition is a door of a safe that can open and close, the bill processing unit is provided on the door in such a manner that the bill processing unit can open and close with respect to the door, the storage unit is arranged in the safe, the passage opening is formed in the door, a bill passage of the bill processing unit and the passage opening can be aligned with each other when the bill processing unit closes with respect to the door, and the door can be operated to open and close when the bill processing unit opens with respect to the door.

Alternatively, the partition is a wall of a vault, the bill processing unit is provided on an outside of the wall, the storage unit is arranged in the vault, the passage opening is formed in the wall, and a bill passage of the bill processing unit and a bill passage of the storage unit couple each other via the passage opening.

Alternatively, the partition is a wall between a lobby room and a second room, the bill processing unit is provided on a lobby-room side of the wall, the storage unit is arranged in the second room, the passage opening is formed in the wall, and a bill passage of the bill processing unit and a bill passage of the storage unit couple each other via the passage opening.

In the above cases, the bill handling machine may be adapted to function as a circulatory-type bill depositing and dispensing machine.

Alternatively, this invention is characterized by following features. That is, this invention is a circulating-type bill depositing and dispensing machine comprising: a bill processing unit that can conduct a bill depositing process and a bill dispensing process: a storage unit that can receive and store bills that has been deposited through the bill processing unit and that can feed out the bills; and a storage cassette that can receive and store the bill that has been fed out from the storage unit and that can feed out the bill; wherein the storage cassette is arranged behind the storage unit in a column-like manner, and a second storage cassette, which can receive and store the bill that has been fed out from the storage cassette and which can feed out the bill, can be serially arranged behind the storage cassette in a column-like manner.

According to the feature, the number of storage cassettes may be easily changed. That is, it may be easy to keep up with increase or decrease of the number of kinds of stored bills and/or increase or decrease of the amount of stored bills.

In detail, for example, the storage cassette has: at least a storage bin arranged therein; a depositing passage through which the bill is sent to the storage bin; and a dispensing passage through which the bill is fed out from the storage bin; and the depositing passage and the dispensing passage can connect with a depositing passage and a dispensing passage of the serially arranged second storage cassette.

In the case, preferably, the storage cassette has two storage bins that have the same structure and are vertically arranged, the bill is adapted to be selectively sent from the depositing passage to the respective two storage bins, and the bill is adapted to be selectively fed out from the respective two storage bins to the dispensing passage.

In addition, preferably, the bill is adapted to be sent to the storage bin through an upper portion of the storage bin and fed out from the storage bin through a lower portion of the storage bin, the storage bin has: a feeding-out unit arranged at a lower portion of the storage bin, which can feed out the bill pressed thereto; a stage that is vertically movable in the storage bin and that can receive and accumulate bills sent through the upper portion of the storage bin thereon; a pressing body that can press the bills accumulated on the stage to press a lowest bill of the bills to the feeding-out unit, the pressing body being throughout or partly made of a magnetic material; and an electromagnet arranged at a upper portion of the storage bin for sticking to and holding the pressing body when the stage is moved up in order to allow the bills to be sent onto the stage; and the electromagnet is adapted to release the pressing body in such a manner that the pressing body falls on and holds the accumulated bills, when the accumulated bills are fed out or the storage cassette is pulled out.

In addition, preferably, the storage cassette has an outside shell and an inside shell that is fitted in the outside shell, the depositing passage and the dispensing passage are arranged in the outside shell, the storage bin is arranged in the inside shell, and the inside shell is removable from the outside shell and portable.

### BRIEF DESCRIPTION OF THE DRAWINGS

FIG. 1 is a schematic perspective view of a bill processing unit in its open state of a first embodiment wherein the invention is applied to a safe;

FIG. 2 is a schematic sectional view of the first embodiment shown in FIG. 1 in its using state;

FIG. 3 is an enlarged sectional view of a bank note cassette shown in FIG. 2;

FIGS. 4A to 4C are schematic views for explaining an operation of a storage bin of the bank note cassette shown in FIG. 3;

FIG. 5 is a schematic sectional view of a second embodiment wherein the invention is applied to a vault, in its using state;

FIG. 6 is a schematic sectional view of a third embodiment wherein the invention is applied to a lobby-room, in its using state;

FIG. 7 is a schematic sectional view of a fourth embodiment wherein the invention is applied to a horizontal safe, in its using state;

FIG. 8 is a schematic sectional view of a fifth embodiment;

FIG. 9 is a schematic sectional view of a case wherein another bank note cassette is added to the embodiment shown in FIG. 8;

FIG. 10 is a schematic sectional view of a case wherein three bank note cassettes are added to the embodiment shown in FIG. 8;

FIG. 11 is a schematic sectional view of a temporary storing part of a bill processing unit in its bill-accumulating state;

FIG. 12 is a schematic sectional view of the temporary storing part of the bill processing unit in its bill-feeding state;

FIG. 13 is a schematic sectional view of the temporary storing part of the bill processing unit in its bill-refunding state;

FIG. 14 is an enlarged sectional view of a bank note cassette shown in FIGS. 9 and 10;

FIGS. 15A to 15C are schematic views for explaining an operation of a storage bin of the bank note cassette shown in FIG. 14;

FIG. 16 is a schematic perspective view of a bill processing unit in its open state of a sixth embodiment wherein the invention is applied to a safe; and

FIG. 17 is a schematic sectional view of the sixth embodiment shown in FIG. 16 in its using state.

### BEST MODE FOR CARRYING OUT THE INVENTION

Embodiments of the invention are explained in more detail with reference to the drawings.

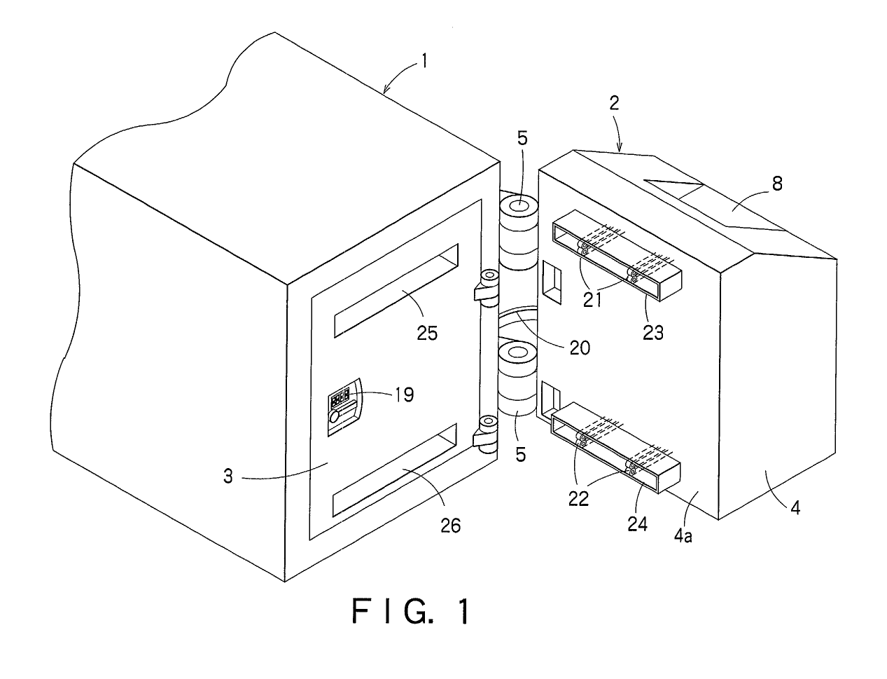

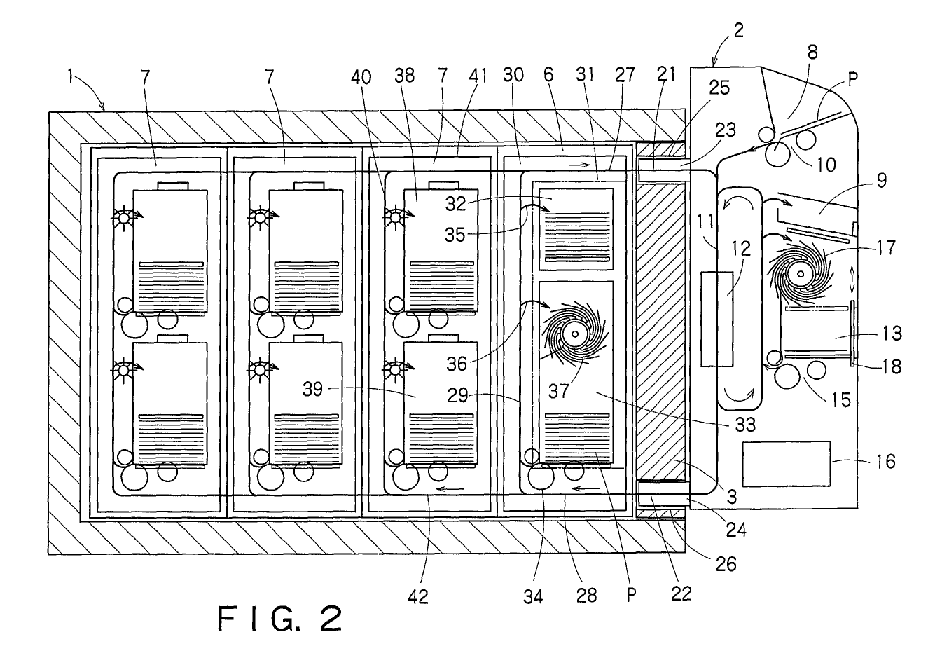

FIGS. 1 and 2 show a first embodiment wherein the invention is applied to a safe. As shown in FIGS. 1 and 2, the first embodiment mainly consists of a safe 1 and a bill processing unit 2.

In the embodiment, a door 3 is provided in a door side of the safe 1. The door 3 can open and close with respect to the door side of the safe 1. An outer case 4 defining an outer fence of the bill processing unit 2 is mounted to the door side of the safe 1 via hinges 5, 5. Thus, the outer case 4 can also open and close with respect to the door side of the safe 1. Thus, when the outer case 4 closes with respect to the door side, a backside plate 4a of the outer case 4 is adapted to conceal the door 3 of the safe 1. Then, the door 3 forms a partition separating the safe 1 and the bill processing unit 2.

In the safe 1, as shown in FIG. 2, a mixed bank note cassette 6 is disposed just near to the door 3. Behind the mixed bank note cassette 6, one to several (three in FIG. 2) bank note cassettes 7 are disposed correspondingly to the number of kinds of bills. Then, the mixed bank note cassette 6 and the bank note cassettes 7 form a storage unit. Herein, the bill handling machine of the embodiment is a circulating-type bill depositing and dispensing machine wherein the bills that has been deposited can be refunded again.

As shown in FIG. 2, the bill processing unit 2 has: a depositing part 8 provided at a front upper portion of the outer case 4, into which the bills P are inserted; a refunding part 9 (rejection port) provided just below the depositing part 8 in the front surface of the outer case 4; a longitudinal looped transfer passage 11 arranged in the outer case 4 for transferring the bills that are inserted through the depositing part 8 and fed out by feeding means 10 one by one; an discriminating part 12 arranged on the way of the transfer passage 11 for examining kinds of the bills and/or approving the bills; a temporary storing part 13 for temporarily storing the bills that have been discriminated and approved by the discriminating part 12; and feeding means 15 arranged at a lower portion of the temporary storing part 13 for feeding out the stored bills P and sending them to the mixed bank note cassette 6 in the safe 1. Flappers are disposed at divergence junctions between the transfer passage 11 and the respective components as usual. Operations of the respective components and the flappers are controlled by a controller 16.

In addition, in FIG. 2, a numeral reference 17 indicates an impeller for smoothly accumulating the bills P transferred to the temporary storing part 13. A numeral reference 18 indicates a shutter that can open when the bills are paid back. In FIG. 1, a numeral reference 19 indicates a key for the door 3 of the safe 1. A numeral reference 20 indicates a flexible cable electrically connecting the inside of the safe 1 and the bill processing unit 2.

Passage portions 23, 24 including transfer passages 21, 22 respectively branched from an upper portion and a lower portion of the transfer passage 11 are protruded from an upper portion and a lower portion of the backside plate 4a of the outer case 4, respectively. As shown in FIG. 1, each of the protruded passage portions 23, 24 has a rectangular shape having a width larger than widths of the bills. The door 3 of the safe 1 has passage openings 25, 26 into which the protruded passage portions 23, 24 can be fitted substantially tightly, respectively. That is, each of the passage openings 25, 26 has also a rectangular shape slightly larger than the protruded passage portion 23 or 24. Then, when the outer case 4 closes with respect to the door side of the safe 1, the transfer passages 21, 22 of the passage portions 23, 24 are aligned with and connect with transfer passages 27, 28 formed at an upper portion and a lower portion of the mixed bank note cassette 6, respectively.

The mixed bank note cassette 6 and the bank note cassettes 7, 7, 7 are conveyed into and from the inside of the safe 1 while the door 3 opens with respect to the door side of the safe 1. When these cassettes are set at respective predetermined positions in the safe 1, these cassettes are connected to a or more driving sources for the transfer of the bills and for operations of the respective components. For example, driving force is transmitted from the driving sources to the components via a or more moving belts.

The mixed bank note cassette 6 has a double structure. That is, the cassette 6 has an outside shell 30 and an inside shell 31 that is fitted in the outside shell 30. The transfer passages 27, 28 and a longitudinal transfer passage 29 connecting to the transfer passages 27, 28 are arranged in the outer shell 30. An upper storage bin 32 is formed at an upper portion in the inside shell 31. A lower storage bin 33 is formed at a lower portion in the inside shell 31. A feeding mechanism 34, which can feed out the bills P one by one, is arranged at a base portion of the lower storage bin 33. In addition, passages 35, 36 are branched from the vertical longitudinal passage 29 in the outside shell 30 in order to send the bills to the respective storage bins 32, 33. A numeral reference 37 designates an impeller for smoothly accumulating and storing the bills P. Thus, in the mixed bank note cassette 6, the inside shell 31 can be removed from the outside shell 30. Then, only the inside shell 31 can be conveyed to an accounting office or the like.

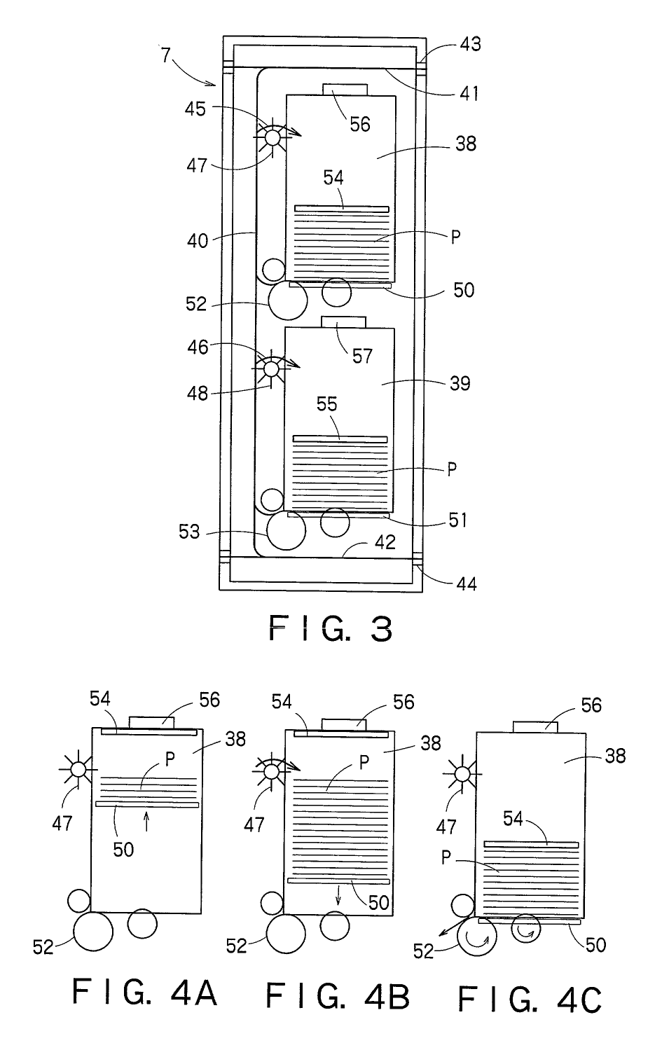

The bank note cassettes 7, 7, 7 have the same structure. FIG. 3 shows an enlarged sectional view of the structure. As shown in FIG. 3, an upper storage bin 38 is formed at an upper portion in the cassette 7. A lower storage bin 39 is formed at a lower portion in the cassette 7. The upper storage bin 38 is disposed just above the lower storage bin 39. A vertical longitudinal passage 40 is arranged along and near to a backside (left in FIG. 3) wall of the cassette 7. An upper portion and a lower portion of the transfer passage 40 are connected to an upper transfer passage 41 and a lower transfer passage 42, respectively. The upper transfer passage 41 connects with the transfer passage 27 of the mixed bank note cassette 6 via a passage portion 43 and with another upper transfer passage 41 of an adjacent (rear) bank note cassette 7. The lower transfer passage 42 connects with the transfer passage 28 of the mixed bank note cassette 6 via a passage portion 44 and with another lower transfer passage 42 of the adjacent (rear) bank note cassette 7. As shown in FIG. 2, in the rearmost (leftmost) bank note cassette 7, the upper and lower transfer passages 41 and 42 connect only with the transfer passages 41 and 42 of the right adjacent bank note cassette 7.

A branched path 45 is branched from the vertical transfer passage 40 in order to send the bills into the storage bin 38. An impeller 47 is disposed on the way of the branched path 45 in order to send the bills more smoothly. Similarly, a branched path 46 is branched from the vertical transfer passage 40 in order to send the bills into the storage bin 39. An impeller 48 is disposed on the way of the branched path 46 in order to send the bills more smoothly.

A receiving plate 50 (stage) is vertically movable in the storage bin 38. A feeding-out mechanism 52 that can feed out the bills one by one is arranged at a base portion of the storage bin 38. Thus, the bills are adapted to be sent to the bill processing unit 2 via the transfer passages 40 and 41. Similarly, a receiving plate 51 (stage) is vertically movable in the storage bin 39. A feeding-out mechanism 53 that can feed out the bills one by one is arranged at a base portion of the storage bin 39. Thus, the bills are adapted to be sent to the bill processing unit 2 via the transfer passages 40 and 41.

A pressing plate 54 (pressing body) that has been throughout or partly made of a magnetic material is placed in the storage bin 38. An electromagnet 56 is mounted on an upper wall of the storage bin 38. When the bills P accumulated on the receiving plate 50 are fed out, magnetic force is adapted to disappear from the electromagnet 56. Then, the pressing plate 54 falls on the accumulated bills P and presses down them because of its own weight. Thus, suitable frictional force is generated between the lowermost bill P and the feeding-out mechanism 52. On the other hand, when the bills P are received into the storage bin 38, the receiving plate 50 is lifted up and the electromagnet 56 sticks to the pressing plate 54 in order to allow the bills P to be sent onto the receiving plate 50. Similarly, a pressing plate 55 (pressing body) that has been throughout or partly made of a magnetic material is placed in the storage bin 39. An electromagnet 57 is mounted on an upper wall of the storage bin 39. When the bills P accumulated on the receiving plate 51 are fed out, magnetic force is adapted to disappear from the electromagnet 57. Then, the pressing plate 55 falls on the accumulated bills P and presses down them because of its own weight. Thus, suitable frictional force is generated between the lowermost bill P and the feeding-out mechanism 53. On the other hand, when the bills P are received into the storage bin 39, the receiving plate 51 is lifted up and the electromagnet 57 sticks to the pressing plate 55 in order to allow the bills P to be sent onto the receiving plate 51.

Then, an operation of the above embodiment is explained.

When a or more bills P are deposited, the bills P to be deposited are inserted into the depositing part 8 of the bill processing unit 2. After a predetermined depositing instruction is given, the feeding-out mechanism 10 operates to feed out the bills one by one. The bills are transferred through the transfer passage 11, and discriminated by the discriminating part 12 as to the denomination, whether the bill is true or falsehood and whether the bill is fit or unfit. If a bill is judged to be a normal bill, the bill is sent to the temporary storing part 13. If a bill is judged to be unfit or counterfeit, that is, if the bill is not discriminated normal, the bill is sent back to the refunding part 9 (rejection port).

If the bills are to be stored with classified according to kind, the bills are sent to the respective storage bins 38 and 39, each corresponding to a kind of bill.

When a or more bills P are paid back, according to an instructed amount of money, corresponding number of bills P are fed out from the storage bins 38 and 39 in the bank note cassettes 7, respectively. In the case, as shown in FIGS. 4A to 4C, magnetic force is adapted to disappear from the electromagnet 56 in a state shown in FIG. 4A or FIG. 4B wherein the storage bin 38 stores the bills to be fed out. Then, the pressing plate 54 falls on the accumulated bills and presses down them because of its own weight. Then, the receiving plate 50 is moved down to the lowest position (FIG. 4C), and the lowermost bill P is pressed to the feeding-out mechanism 52 to be fed out.

The fed bills are sent to the bill processing unit 2 via the transfer passages 40 and 41, the transfer passage 27 of the mixed bank note cassette 6 and the transfer passage 21 of the passage portion 23. Then, the bills are discriminated by the discriminating part 12, and paid back to the refunding part 9.

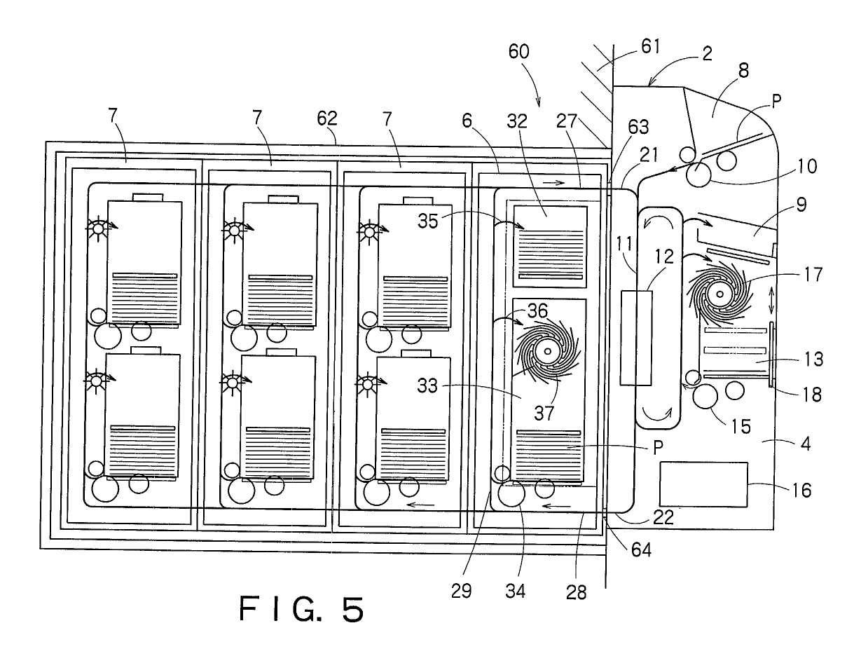

FIG. 5 is a schematic sectional view of a second embodiment wherein the invention is applied to a vault 60. As shown in FIG. 5, a partition 61 separates the vault 60 and an outside area. Only managers can enter the vault 60. A backside wall of an outer case 4 of a bill processing unit 2 is closely fixed to an outside surface of the partition 61. A mixed bank note cassette 6 and bank note cassettes 7, 7, 7 are disposed in a frame 62 (vault 60) built in an inside area with respect to the partition 61. The mixed bank note cassette 6 and the bank note cassettes 7, 7, 7 form a storage unit. Similarly to the safe 1, the bills P can pass between the bill processing unit 2 and the mixed bank note cassette 6, through passage openings 63 and 64 formed in the partition 61.

Each component of the embodiment shown in FIG. 5 is substantially the same as that shown in FIG. 2. Thus, the same numeral references correspond to the same components as the embodiment shown in FIG. 2. The explanation of the same structures and components is not repeated. In the embodiment shown in FIG. 5, the bills P are transferred substantially similarly to the embodiment shown in FIG. 2.

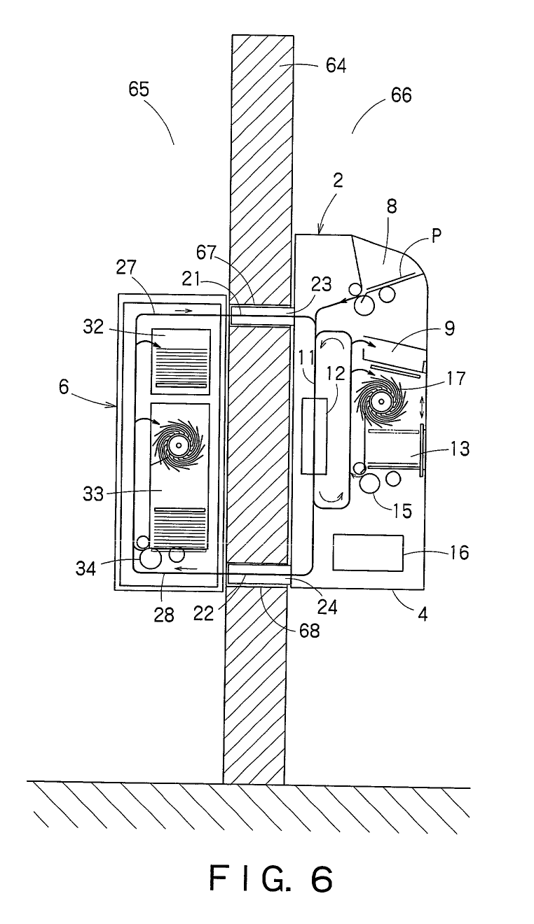

FIG. 6 is a schematic sectional view of a third embodiment wherein the invention is applied to a lobby-room of a bank, a hotel or the like. As shown in FIG. 6, a partition 64 separates the lobby-room 66 and another second room 65. A mixed bank note cassette 6 that forms a storage unit is closely fixed to a second-room surface of the partition 64. An outer case 4 of a bill processing unit 2 is closely fixed to a lobby-room surface of the partition 64. Similarly to the safe 1, the bills P can pass between the bill processing unit 2 and the mixed bank note cassette 6, through passage openings 67 and 68 formed in the partition 64.

Each component of the embodiment shown in FIG. 6 is substantially the same as that shown in FIG. 2. Thus, the same numeral references correspond to the same components as the embodiment shown in FIG. 2. The explanation of the same structures and components is not repeated.

When a or more bills P are deposited, the bills P to be deposited are inserted into the depositing part 8 of the bill processing unit 2. After a predetermined depositing instruction is given, the feeding-out mechanism 10 operates to feed out the bills one by one. The bills are transferred through the transfer passage 11, and discriminated by the discriminating part 12 as to the denomination, whether the bill is true or falsehood and whether the bill is fit or unfit. If a bill is judged to be genuine, the bill is sent to the temporary storing part 13. If a bill is judged to be unfit or counterfeit, that is, if the bill is not discriminated normal, the bill is sent back to the refunding part 9 (rejection port).

If the bills are received in the temporary storing part 13 and are approved, that is, if an approval instruction is given, the bills are fed out from the temporary storing part 13 by the feeding mechanism 15, and sent to the storage bin 33, via the transfer passages 11 and 12, the transfer passages 28 and 29 of the mixed bank note cassette 6 and the branched path 36. When the storage bin 33 becomes full, the machine is generally stopped. Alternatively, the bills stored in the storage bin 33 may be fed out by the feeding-out mechanism 34, and sent to the upper storage bin 32.

As shown in FIG. 6, in the case of using only the mixed bank note cassette 6 as the storage unit, it is preferable that kind of each bill is stored by a memory (not shown). Thus, the bills may be used for refunding.

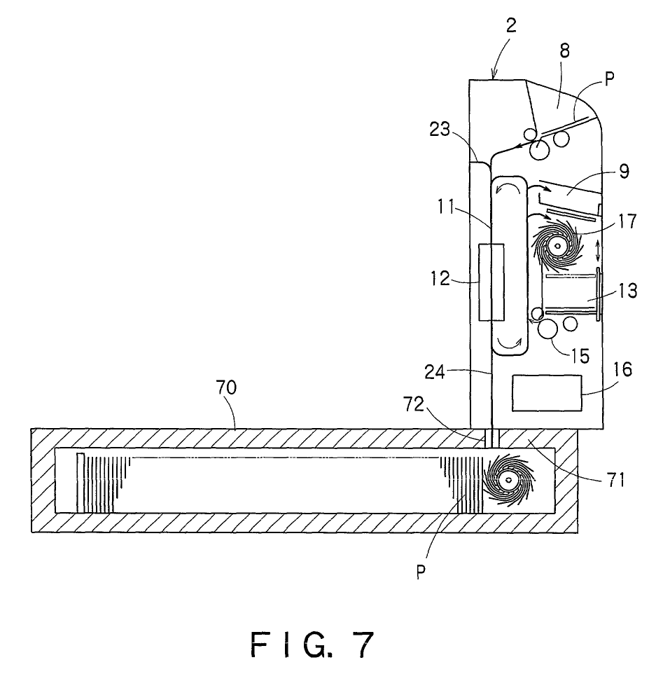

In the above embodiments, the bills are sent to the storage bin through the upper portion thereof and fed out therefrom through the base lower portion thereof. However, as seen from a fourth embodiment shown in FIG. 7, if it is not requested to feed out the bills, the storage unit may be formed by a horizontal storing box 70. Then, the bills P may be stored with standing. In the case, if the storing box 70 has a safe structure and if a partition 71 forms a wall thereof, this invention is applicable to the storing box 70 by forming a passage opening 72 in the partition 71.

The bill processing unit 2 shown in FIG. 7 is substantially the same as that shown in FIG. 2. Thus, the same numeral references correspond to the same components as the embodiment shown in FIG. 2. The explanation of the same structures and components is not repeated.

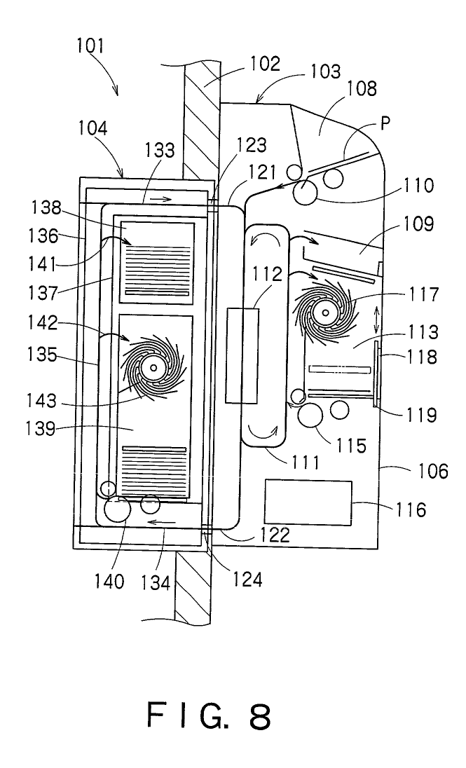

Then, a fifth embodiment of the invention is explained with reference to FIGS. 8 to 10.

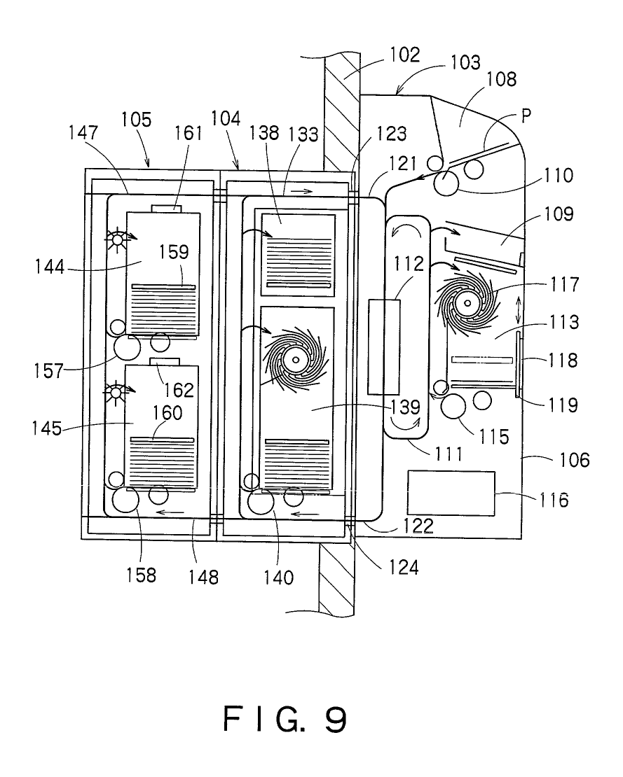

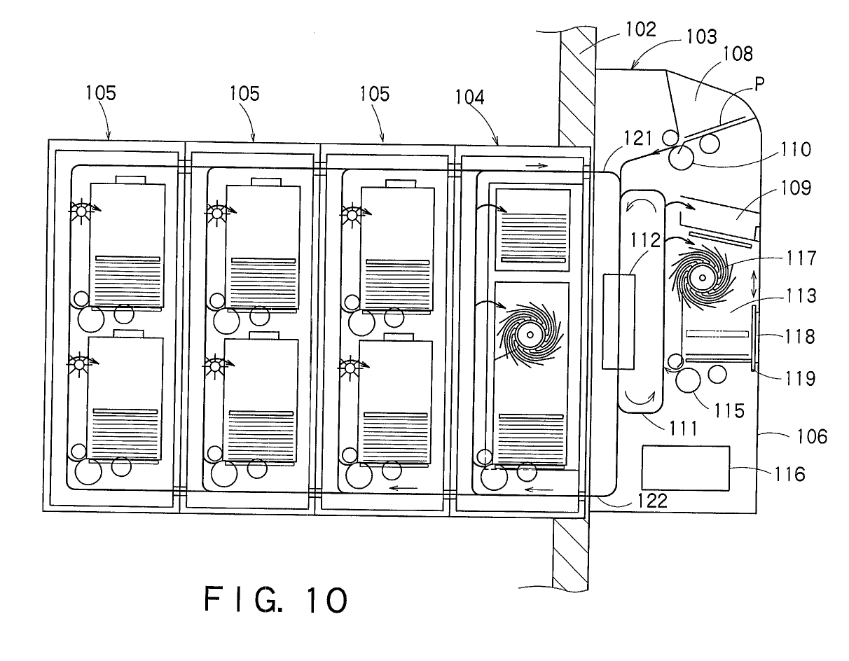

FIG. 8 shows a case wherein only one mixed bank note cassette 104 is used as a storage unit. FIG. 9 shows a case wherein one bank note cassette 105 is arranged behind the mixed bank note cassette 104 in a column-like manner. FIG. 10 shows a case wherein three bank note cassettes 105 are serially arranged behind the mixed bank note cassette 104 in a column-like manner. The number of serially arranged bank note cassettes 105 is variable dependently on the number of kinds of bills and/or the amount of bills.

As shown in FIGS. 8 to 10, a partition 102 separates a room 101 such as a vault and an outside area. Only managers can enter the room 101. A bill processing unit 103 is disposed in the outside area with respect to the partition 102. A storage unit for bills P is disposed in the room 101.

As shown in FIGS. 8 to 10, the bill processing unit 103 has: a depositing part 108 provided at a front upper portion of an outer case 106 of the bill processing unit 103, into which the bills P are inserted; a refunding part 109 (rejection port) provided just below the depositing part 108 in the front surface of the outer case 106; a longitudinal looped transfer passage 111 arranged in the outer case 106 for transferring the bills that are inserted through the depositing part 108 and fed out by feeding means 110 one by one; an discriminating part 112 arranged on the way of the transfer passage 111 for discriminating the denomination and/or authenticating and evaluating fitness of the bills; a temporary storing part 113 for temporarily storing the bills that have been discriminated and approved by the discriminating part 112; and feeding means 115 arranged at a lower portion of the temporary storing part 113 for feeding out the stored and approved bills P and sending them to the mixed bank note cassette 104 in the room 101. Flappers are disposed at divergence junctions between the transfer passage 111 and the respective components as usual. Operations of the respective components and the flappers are controlled by a controller 116.

In FIGS. 8 to 10, a numeral reference 117 indicates an impeller for smoothly accumulating the bills P transferred to the temporary storing part 113. A numeral reference 118 indicates a port for refunding the stored bills P when the deposit is not approved, or for paying-out the stored bills P when withdrawal is requested. A numeral reference 119 indicates a shutter that can open and close the port 118.

Passage portions 123, 124 including transfer passages 121, 122 respectively branched from an upper portion and a lower portion of the transfer passage 1 1 are formed at an upper portion and a lower portion of a backside wall of the outer case 106, respectively. The transfer passages 121, 122 of the passage portions 123, 124 are aligned with and connect with transfer passages 133, 134 formed at an upper portion and a lower portion of the mixed bank note cassette 104, respectively.

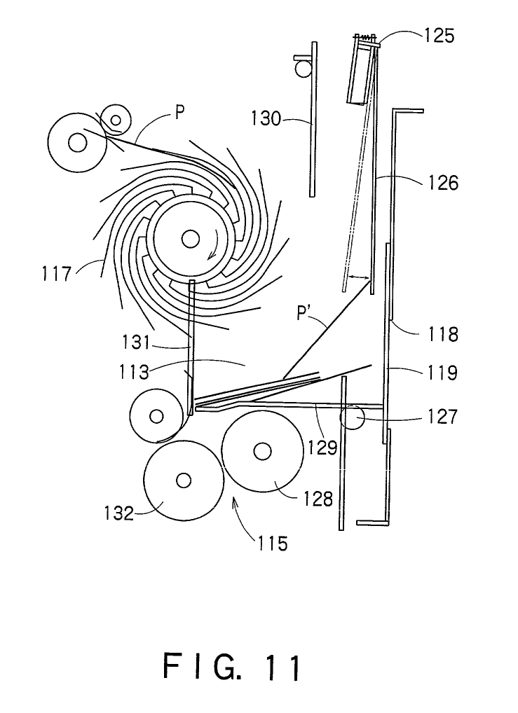

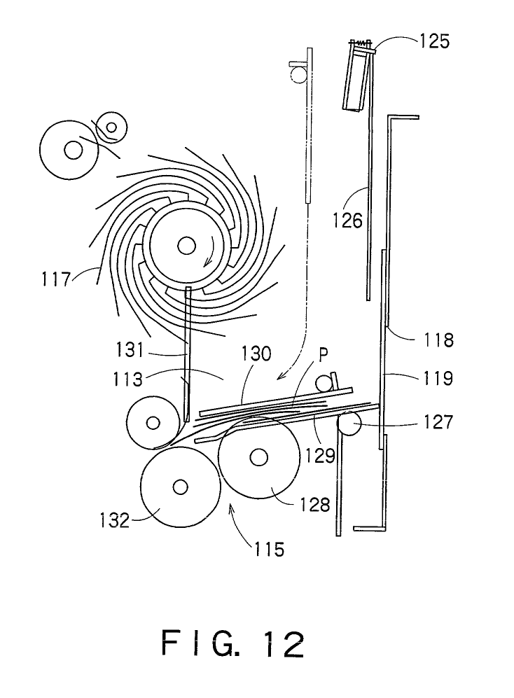

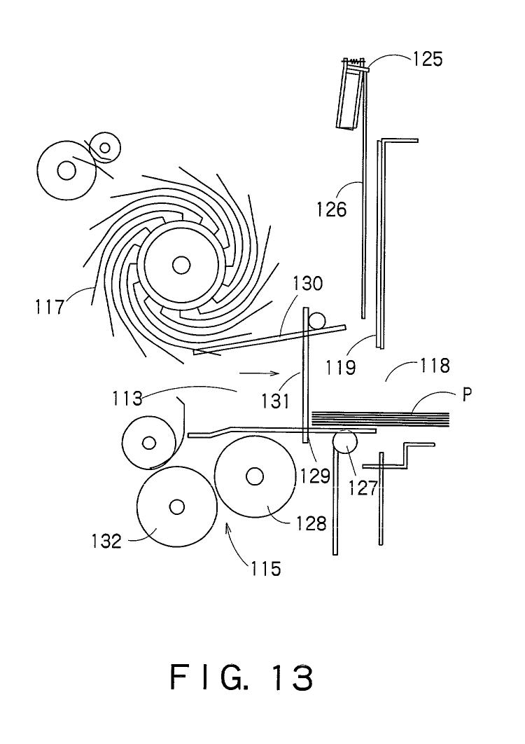

The temporary storing part 113 of the bill processing unit 103 is explained with reference to FIGS. 11 to 13. FIG. 11 shows the temporary storing part 113 in its bill-accumulating state, FIG. 12 shows the temporary storing part 113 in its bill-feeding state, and FIG. 13 shows the temporary storing part 113 in its bill-refunding state.

As shown in FIGS. 11 to 13, a regulating plate 126 is suspended along an inside surface of the shutter 119 of the refunding port 118. An upper end of the regulating plate 126 is supported by a supporting part 125 in such a manner that a lower end of the regulating plate 126 reaches a vicinity of an upper end of the refunding port 118. A bill P transferred through the impeller 117 may stand up in the temporary storing part 113, which is detected by a not shown sensor. In such a case, the regulating plate 126 swings from a position shown by a real line in FIG. 11 to a position shown by a two-dotted line in FIG. 11 by means of driving means such as a solenoid. Thus, the standing bill is moved into its horizontal posture. The transferred bills are accumulated on a base plate 129. The base plate 129 has a fulcrum 127 on the side of the refunding port 118. Thus, the base plate can swing from a horizontal position above a kicker-roller 128 to a position below an upper surface of the kicker-roller 128 by means of driving means such as a solenoid. The kicker-roller 128 serves as a feeding-out mechanism 115. A pressing plate 130 is adapted to move down from a standing attitude shown by a real line in FIG. 11 to a substantially horizontal attitude shown by a real line in FIG. 13 by means of a moving mechanism not shown. Thus, the pressing plate 130 can press down and hold the bills P accumulated on the base plate 129 when the bills P are fed out. A pushing member 131 is arranged to regulate tail ends of the bills P accumulated on the base plate 129 (see FIGS. 11 and 12). The pushing member 131 is horizontally movable from a position shown in FIGS. 11 and 12 to a forward position shown in FIG. 13 when the accumulated bills P are paid back to the refunding port 118.

Thus, the bills P to be sent to the temporary storing part 113 are received by the impeller 117 via the discriminating part 112 and the branched path. Then, the bills P are guided downward by rotation of the impeller 117 in a direction shown by an arrow in FIG. 11, and accumulated on the base plate 129 that has been horizontal. If a bill is not guided smoothly onto the base plate 129, that is, if a bill stands up like a bill P′ shown in FIG. 11, the sensor (not shown) detects the situation and the regulating plate 126 swings to the position shown by the two-dotted line in FIG. 11. Thus, the standing bill P′ falls down and becomes flat on the base plate 129. That is, the bill P′ is also accumulated smoothly. The sensor may be formed by a light-emitting element disposed at a side wall of the temporary storing part 113, a reflecting plate such as a mirror disposed above the refunding port 118 in the temporary storing part 113 and a light-receiving element disposed at another side wall of the temporary storing part 113. In the case, when the light-receiving element does not receive a light emitted from the light-emitting element, it is thought that a bill stands up and interrupts the light.

When the accumulated bills P are fed out to the mixed bank note cassette 104, as shown in FIG. 12, the base plate 129 swings down to cause an under surface of the lowest bill P to come in contact with the kicker-roller 128. Then, the pressing plate 130 falls down on and presses down the accumulated bills. After that, the kicker-roller 128 and a feed roller 132 are driven to feed out the bills one by one, as the feeding-out mechanism 115.

When the bills P accumulated on the base plate 129 are paid back or dispensed, as shown in FIG. 13, the shutter 119 opens and the pushing member 131 moves forward. Then, the tail ends of the bills P are pushed forward so that the bills are protruded through the refunding port 118 by substantially half height, which is convenient to take away the bills by hand.

The mixed bank note cassette 104 has a double structure. That is, the cassette 104 has an outside shell 136 and an inside shell 137 that is fitted in the outside shell 136. The upper dispensing transfer passage 133, the lower depositing transfer passage 134 and a vertical longitudinal transfer passage 135 connecting with the transfer passages 133, 134 are arranged in the outer shell 136. An upper storage bin 138 is formed at an upper portion in the inside shell 137. A lower storage bin 139 is formed at a lower portion in the inside shell 137. A feeding mechanism 140, which can feed out the bills P one by one, is arranged at a base portion of the lower storage bin 139. In addition, passages 141, 142 are branched from the vertical longitudinal passage 135 in the outside shell 136 in order to send the bills to the respective storage bins 138, 139. A numeral reference 143 designates an impeller for smoothly accumulating and storing the bills P. Thus, in the mixed bank note cassette 104, the inside shell 137 can be removed from the outside shell 30. Then, only the inside shell 137 can be conveyed to an accounting office or the like.

The bank note cassettes 105 have the same structure. FIG. 14 shows an enlarged sectional view of the structure. As shown in FIG. 14, an upper storage bin 144 is formed at an upper portion in the cassette 105. A lower storage bin 145 is formed at a lower portion in the cassette 105. The upper storage bin 144 is disposed just above the lower storage bin 145. A vertical longitudinal passage 146 is arranged along and near to a backside (left in FIG. 14) wall of the cassette 105. An upper portion and a lower portion of the transfer passage 146 are connected to an upper transfer passage 147 and a lower transfer passage 148, respectively. The upper transfer passage 147 connects with the transfer passage 133 of the mixed bank note cassette 104 via a passage portion 149 and with another upper transfer passage 147 of an adjacent (rear) bank note cassette 105. The lower transfer passage 148 connects with the transfer passage 134 of the mixed bank note cassette 104 via a passage portion 150 and with another lower transfer passage 148 of the adjacent (rear) bank note cassette 105. As shown in FIG. 10, in the rearmost (leftmost) bank note cassette 105, the upper and lower transfer passages 147 and 148 connect only with the transfer passages 147 and 148 of the right adjacent bank note cassette 105. In the case, the upper and lower transfer passages 147 and 148 in the rearmost (leftmost) bank note cassette 105 may be closed with respect to the left wall. Alternatively, the upper and lower transfer passages 147 and 148 in the rearmost (leftmost) bank note cassette 105 may be connectable for transfer passages 147 and 148 of a possible left adjacent bank note cassette 105.

A branched path 151 is branched from the vertical transfer passage 146 in order to send the bills into the storage bin 144. An impeller 153 is disposed on the way of the branched path 151 in order to send the bills more smoothly. Similarly, a branched path 152 is branched from the vertical transfer passage 146 in order to send the bills into the storage bin 145. An impeller 154 is disposed on the way of the branched path 152 in order to send the bills more smoothly.

A receiving plate 155 (stage) is vertically movable in the storage bin 144. A feeding-out mechanism 157 that can feed out the bills one by one is arranged at a base portion of the storage bin 144. Thus, the bills are adapted to be sent to the bill processing unit 103 via the transfer passages 146 and 147. Similarly, a receiving plate 156 (stage) is vertically movable in the storage bin 145. A feeding-out mechanism 158 that can feed out the bills one by one is arranged at a base portion of the storage bin 145. Thus, the bills are adapted to be sent to the bill processing unit 103 via the transfer passages 146 and 147.

A pressing plate 159 (pressing body) that has been throughout or partly made of a magnetic material is placed in the storage bin 144. An electromagnet 161 is mounted on an upper wall of the storage bin 144. When the bills P accumulated on the receiving plate 155 are fed out, magnetic force is adapted to disappear from the electromagnet 161. Then, the pressing plate 159 falls on the accumulated bills P and presses down them because of its own weight. Thus, suitable frictional force is generated between the lowermost bill P and the feeding-out mechanism 157. On the other hand, when the bills P are received into the storage bin 144, the receiving plate 155 is once lifted up to the uppermost position, the electromagnet 161 sticks to the pressing plate 159 and the receiving plate 155 is again moved down in order to allow the bills P to be sent onto the receiving plate 155.

Similarly, a pressing plate 160 (pressing body) that has been throughout or partly made of a magnetic material is placed in the storage bin 145. An electromagnet 162 is mounted on an upper wall of the storage bin 145. When the bills P accumulated on the receiving plate 156 are fed out, magnetic force is adapted to disappear from the electromagnet 162. Then, the pressing plate 160 falls on the accumulated bills P and presses down them because of its own weight. Thus, suitable frictional force is generated between the lowermost bill P and the feeding-out mechanism 158. On the other hand, when the bills P are received into the storage bin 145, the receiving plate 156 is once lifted up to the uppermost position, the electromagnet 162 sticks to the pressing plate 160 and the receiving plate 156 is again moved down in order to allow the bills P to be sent onto the receiving plate 156.

Then, an operation of the fifth embodiment is explained.

When a or more bills P are deposited, the bills P to be deposited are inserted into the depositing part 108 of the bill processing unit 103. After a predetermined depositing instruction is given, the feeding-out mechanism 110 operates to feed out the bills one by one. The bills are transferred through the transfer passage 111, and discriminated by the discriminating part 112 as to the denomination, whether the bill is true or falsehood and whether the bill is fit or unfit. If a bill is judged to be a normal bill, the bill is sent to the temporary storing part 113. If a bill is judged to be unfit or counterfeit, that is, if the bill is not normal, the bill is sent back to the dispensing part 109 (rejection port).

As shown in FIG. 8, when the storage unit is formed only by the mixed bank note cassette 104, a depositing operation is explained as below.

At first, the bills P that have been inserted through the depositing part 108 of the bill processing unit 103 are fed out by feeding-out mechanism 110 one by one. Then, the bills P are temporarily stored by the temporary storing part 113. At that time, an amount of money of the temporarily stored bills P is shown by a tellers-machine or a separate display (not shown) as usual.

If the amount of money is approved, according to the approval instruction, the bills P in the temporary storing part 113 are fed out by the feeding-out mechanism 115 one by one. The fed bills P are transferred into the lower storage bin 139 of the mixed bank note cassette 104 through the transfer passage 111, the examining 112, the transfer passage 122, and the depositing transfer passage 142. When the bills P pass through the discriminating part 112, kinds and orders of the bills are stored by a memory (not shown). Thus, kinds and orders of the bills P received by the storage bin 139 are stored by the memory.

A dispensing operation of dispensing the bills P stored in the mixed bank note cassette 104 is explained as below.

At first, contents stored in the memory are searched to check whether bills necessary for a dispensing operation are stored or not. If the necessary number of bills is not stored, the dispensing operation can not be conducted. If the necessary number of bills is stored, the bills are fed out from the storage bin 139 by the feeding-out mechanism 140 one by one. The fed bills P are transferred to the discriminating part 112 through the transfer passage 135, the dispensing transfer passage 133, the transfer passages 121 and 111. If the discriminating part 112 judges that a bill is not an object to be dispensed, the bill is sent to the temporary storing part 113 of the bill processing unit 103 via the transfer passage 111. If the discriminating part 112 judges that a bill is an object to be dispensed, the bill is sent to the dispensing port 109.

In FIG. 9, the storage unit is formed by the mixed bank note cassette 104 and one bank note cassette 105 that is connected to the mixed bank note cassette 104. In a case shown in FIG. 9, the bills can be sent to three storage bins, respectively.

In the case, each of the storage bins 144 and 145 of the bank note cassette 105 corresponds to one predetermined kind of bill to be stored therein. That is, one storage bin is adapted to store only one kind of bill. The storage bins 138 and 139 of the mixed bank note cassette 104 are adapted to be used after the storage bins 144 and/or 145 of the bank note cassette 105 become full. Alternatively, the storage bins 138 and 139 of the mixed bank note cassette 104 are adapted to be used for storing bills of other than the kinds predetermined for the storage bins 144 and 145. Alternatively, the storage bin 139 is used for storing normal bills that can be circulated, but the storage bin 138 is used for storing bills not suitable for being circulated, such as very dirty bills, very damaged bills, bills on which a tape or the like is attached. Then, the storage bin 138 may be provided with no feeding-out mechanism.

In addition, if it is requested to increase the amount of bills and/or the kinds of bills, a or more bank note cassettes 105 are serially arranged in a column manner. The number of bank note cassettes 105 may be two, three (see FIG. 10), four, five, or any other number. If the number of bank note cassettes 105 is two, the number of storage bins may be five. If the number of bank note cassettes 105 is three, the number of storage bins may be seven. If the number of bank note cassettes 105 is four, the number of storage bins may be nine. Similarly, the number of storage bins may be freely increased.

The bills P are sent into the respective storage bins 144 and 145 of the bank note cassettes 105, through the transfer passage 146 branched from the depositing transfer passage 148, and the branched transfer passages 151 and 152.

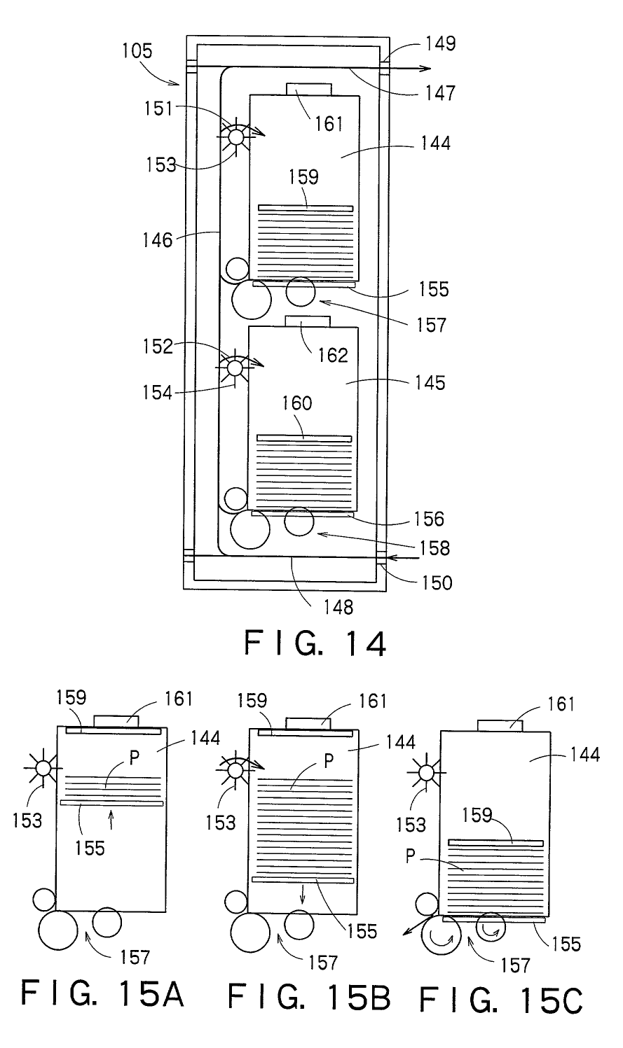

When a or more bills P are fed out from the storage bins 144 and 145 of the bank note cassettes 105, as shown in FIGS. 15A to 15C, magnetic force is adapted to disappear from the electromagnet 161 in a state shown in FIG. 15A or FIG. 15B wherein the storage bin stores the bills to be fed out. Then, the pressing plate 159 falls on the accumulated bills and presses down them because of its own weight. Then, the receiving plate 155 is moved down to the lowest position ( FIG. 15C), and the lowermost bill P is pressed to the feeding-out mechanism 157 to be fed out.

The fed bills are sent to the bill processing unit 103 via the transfer passages 146 and 147, and the transfer passage 133 of the mixed bank note cassette 104. Then, the bills are discriminated by the discriminating part 12. The discriminated bills are paid back to the rejection port 109, or through the temporary storing part 113. Abnormal bills that have been fed out obliquely or overlappedly may be sent to the storage bin 139 of the mixed bank note cassette 104.

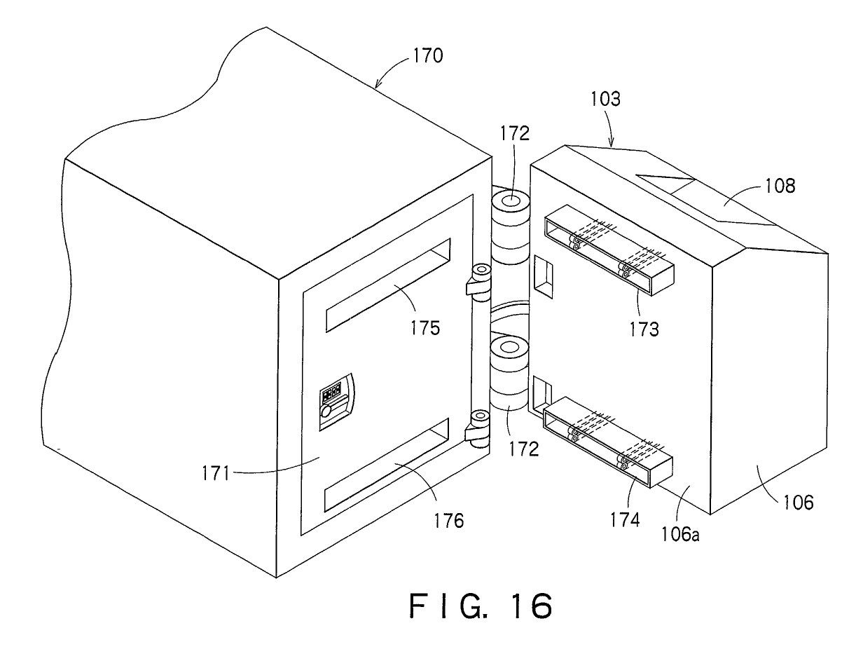

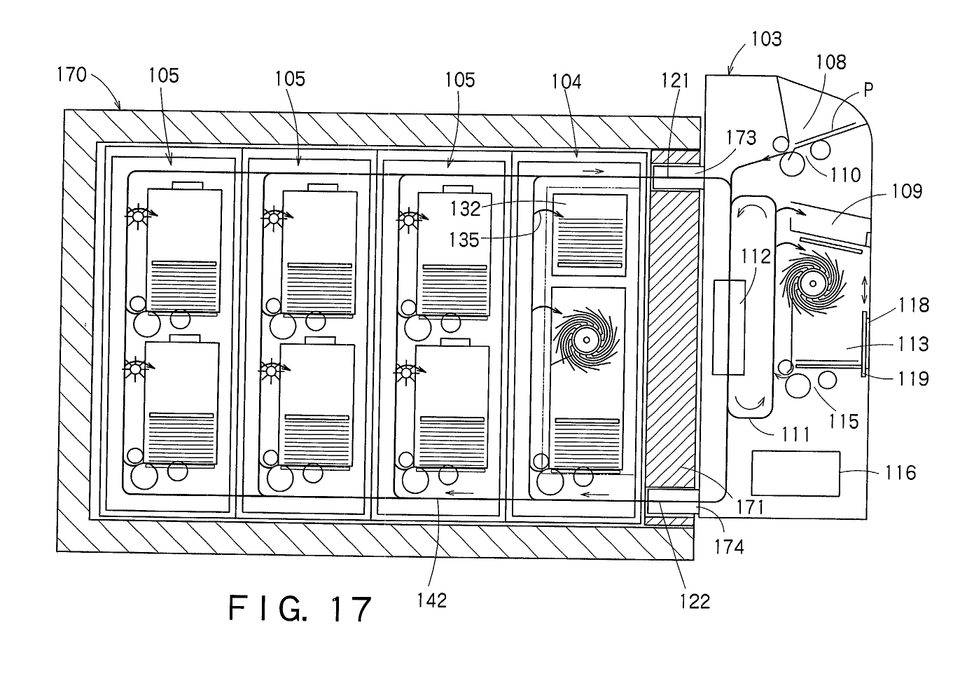

FIGS. 16 and 17 show a sixth embodiment wherein the invention is applied to a safe. As shown in FIGS. 16 and 17, the sixth embodiment mainly consists of a safe 170 and a bill processing unit 103.

In the embodiment, a door 171 is provided in a door side of the safe 170. The door 171 can open and close with respect to the door side of the safe 170. An outer case 106 defining an outer fence of the bill processing unit 103 is mounted to the door side of the safe 170 via hinges 172, 172. Thus, the outer case 106 can also open and close with respect to the door side of the safe 170. Thus, when the outer case 106 closes with respect to the door side, a backside plate 106a of the outer case 106 is adapted to conceal the door 171 of the safe 170. Then, the door 171 forms a partition separating the safe 170 and the bill processing unit 103.

In the safe 170, as shown in FIG. 17, a mixed bank note cassette 104 is disposed just near to the door 171. Behind the mixed bank note cassette 104, one to several (three in FIG. 17) bank note cassettes 105 are disposed correspondingly to the number of kinds of bills, in a column manner. Then, the mixed bank note cassette 104 and the bank note cassettes 105 form a storage unit.

Passage portions 173, 174 including transfer passages 121, 122 respectively branched from an upper portion and a lower portion of the transfer passage 111 are protruded from an upper portion and a lower portion of the backside plate 106a of the outer case 106, respectively. Each of the protruded passage portions 173, 174 has a rectangular shape having a width larger than widths of the bills. The door 171 of the safe 170 has passage openings 175, 176 into which the protruded passage portions 173, 174 can be fitted substantially tightly, respectively. That is, each of the passage openings 175, 176 has also a rectangular shape slightly larger than the protruded passage portion 173 or 174. Then, when the outer case 106 closes with respect to the door side of the safe 170, the transfer passages 121, 122 of the passage portions 173, 174 are aligned with and connect with transfer passages 133, 134 formed at an upper portion and a lower portion of the mixed bank note cassette 104, respectively.

The mixed bank note cassette 104 and the bank note cassettes 105, 105, 105 are conveyed into and from the inside of the safe 170 while the door 171 opens with respect to the door side of the safe 170. When these cassettes are set at respective predetermined positions in the safe 170, these cassettes are connected to a or more driving sources for the transfer of the bills and for operations of the respective components. For example, driving force is transmitted from the driving sources to the components via a or more moving belts.

In the case of the above safe, the bills P are transferred substantially similarly to the embodiment shown in FIGS. 8 to 10. Thus, the same numeral references correspond to the same components as the embodiment shown in FIGS. 8 to 10. The explanation of the same structures and components is not repeated.

As described above, according to the invention, after the depositing operation, the deposited bills don't remain in the bill processing unit. In addition, the storage unit and the bill processing unit are connected with each other only via the passage opening through which the bills can pass. Thus, it is prevented that the bills are stolen even if the bill processing unit is destroyed. Thus, the bill processing unit can be placed more freely, so that availability of the machine may be much improved.

In addition, according to the invention, a transferring machine including the transfer passages to the storage bin and the feeding-out mechanism from the storage bin may be provided in each bank note cassette that can be arranged serially in the column manner. Thus, the bill processing unit and the storage unit may be separated more completely. Thus, even if the number of bank note cassettes is increased, it is unnecessary to rebuild the transferring (driving) device. Thus, the number of bank note cassettes may be easily increased or decreased to achieve a suitable capacity requested by users. Therefore, one machine of the invention is sufficient for different capacities, which is advantageous in cost and in installation space.

In addition, the transfer passages may be formed in the bank note cassette. Thus, when a jam trouble occurs, the transfer passages may be easily inspected by taking off the bank note cassette from the machine. That is, maintenance performance may be improved.

In addition, the electromagnet can stick to and hold the pressing body provided in the storage bin, release the pressing body in such a manner that the pressing body falls on and presses downward the accumulated bills for feeding out the bills, and again stick to and hold the pressing body by lifting the stage. In the case, it is unnecessary to provide with any elevating mechanism for the pressing body. Thus, the structure of the storage bin is so simple that the bank note cassette is easily formed independently. Furthermore, when the removed bank note cassette is conveyed to the accounting office or the like, the electromagnet may preferably release the pressing body such that the pressing body presses downward the accumulated bills. Thus, it is prevented that the accumulated bills are disturbed while the bank note cassette is conveyed.

What is claimed is:

1. A bill handling machine comprising;
a bill processing unit into which a bill is fed and in which the bill is discriminated,
a storage unit that can receive and store the bill that has been discriminated and approved by the bill processing unit,
a partition that separates the bill processing unit and the storage unit, and
a passage opening formed in the partition through which the bill passes.

2. A bill handling machine according to the claim 1, wherein:
the bill processing unit has a depositing part into which bills are inserted.

3. A bill handling machine according to the claim 1, wherein:
the bill processing unit has a refunding part from which the bill that has been discriminated and not approved is paid back.

4. A bill handling machine according to the claim 1, wherein:
the bill processing unit has a temporary storing part in which the bill can be temporarily stored.

5. A bill handling machine according to the claim 1, wherein:
the partition is a door of a safe that can open and close,
the bill processing unit is provided on the door in such a manner that the bill processing unit can open and close with respect to the door,
the storage unit is arranged in the safe,
the passage opening is formed in the door,
a bill passage of the bill processing unit and the passage opening can be aligned with each other when the bill processing unit closes with respect to the door, and
the door can be operated to open and close when the bill processing unit opens with respect to the door.

6. A bill handling machine according to the claim 1, wherein:
the partition is a wall of a vault,
the bill processing unit is provided on an outside of the wall,
the storage unit is arranged in the vault,
the passage opening is formed in the wall, and
a bill passage of the bill processing unit and a bill passage of the storage unit couple each other via the passage opening.

7. A bill handling machine according to the claim 1, wherein:
the partition is a wall between a lobby room and a second room,
the bill processing unit is provided on a lobby-room side of the wall,
the storage unit is arranged in the second room,
the passage opening is formed in the wall, and
a bill passage of the bill processing unit and a bill passage of the storage unit couple each other via the passage opening.

8. A bill handling machine according to the claim 1, adapted to function as a circulating-type bill depositing and dispensing machine.

9. A circulating-type bill depositing and dispensing machine comprising;
a bill processing unit that can conduct a bill depositing process and a bill dispensing process,
a storage unit that can receive and store bills that has been deposited through the bill processing unit and that can feed out the bills, and
a storage cassette that can receive and store the bill that has been fed out from the storage unit and that can feed out the bill, wherein
the storage cassette is arranged behind the storage unit in a column-like manner, and
a second storage cassette, which can receive and store the bill that has been fed out from the storage cassette and which can feed out the bill, can be serially arranged behind the storage cassette in a column-like manner.

10. A circulating-type bill depositing and dispensing machine according to the claim 9, wherein:
the storage cassette has:
at least a storage bin arranged therein,
a depositing passage through which the bills are sent to the storage bin, and
a dispensing passage through which the bills are fed out from the storage bin, and
the depositing passage and the dispensing passage can couple a depositing passage and a dispensing passage of the serially arranged second storage cassette.

11. A circulating-type bill depositing and dispensing machine according to the claim 10, wherein:
the storage cassette has two storage bins that have the same structure and are vertically arranged,
the bill is adapted to be selectively sent from the depositing passage to the respective two storage bins, and
the bill is adapted to be selectively fed out from the respective two storage bins to the dispensing passage.

12. A circulating-type bill depositing and dispensing machine according to the claim 10, wherein:
the bill is adapted to be sent to the storage bin through an upper portion of the storage bin and fed out from the storage bin through a lower portion of the storage bin,
the storage bin has:
a feeding-out unit arranged at a lower portion of the storage bin, which can feed out the bill pressed thereto,
a stage that is vertically movable in the storage bin and that can receive and accumulate bills sent through the upper portion of the storage bin thereon,
a pressing body that can press the bills accumulated on the stage to press a lowest bill of the bills to the feeding-out unit, the pressing body being throughout or partly made of a magnetic material, and
an electromagnet arranged at a upper portion of the storage bin for sticking to and holding the pressing body when the stage is moved up in order to allow the bills to be sent onto the stage, and
the electromagnet is adapted to release the pressing body in such a manner that the pressing body falls on and holds the accumulated bills, when the accumulated bills are fed out or the storage cassette is pulled out.

13. A circulating-type bill depositing and dispensing machine according to the claim 10 wherein:
the storage cassette has an outside shell and an inside shell that is fitted in the outside shell,
the depositing passage and the dispensing passage are arranged in the outside shell,
the storage bin is arranged in the inside shell, and the inside shell is removable from the outside shell and portable.
